(19) United States
(12) Patent Application Publication
(10) Pub. No.: US 2007/0237340 A1
(43) Pub. Date: Oct. 11, 2007

(54) Microphone for Surround-Recording

(76) Inventor: Edwin Pfanzagl-Cardone, Salzburg (AT)

Correspondence Address: Edwin Pfanzagl-Cardone, Goellstrasse 8/1, Salzburg, 5020, AT

(21) Appl. No.: 11/279,154

(22) Filed: Apr. 10, 2006

(51) Int. Cl. H04R 3/00; H04R 1/02; H04R 9/08

(52) U.S. Cl. 381/92; 381/91; 381/356

(57) ABSTRACT

A three channel microphone for surround-sound recording is disclosed. This coincident microphone arrangement consist of three membranes 1, 2, 3 with bi-directional sound pressure gradient characteristics, which are arranged in close proximity to each other. The three membranes are housed each inside cylindrical protective microphone enclosures 5, 6, 7. Each of these enclosures contains the necessary suspension(s) for the microphone membrane and contact wires through which the microphone signal gets from the membrane to the microphone's internal pre-amplifier and is mechanically built in a way which makes it possible to adjust the horizontal orientation of the microphone element as a whole in a range of at least +/−90 deg. from center. The lower part 8 of the microphone body contains the microphone's internal pre-amplifier electronics and multipin signal-connector to connect the three separate microphone signals via shielded audio-cables to the microphone inputs of a sound mixing console.

The invention as described below can be regarded to be an enhancement of the “Blumlein-pair” microphone arrangement (consisting of two crossed figure-of-eight microphones), being one of the inventions described by Alan Dower Blumlein in his U.S. Pat. No. 2,093,540 (for reference see pg. 5, column 2, lines 14-24+FIG. 2) from Sept. 21, 1937.

### FIELD OF THE INVENTION

The present invention relates generally to the field of electrical communication technique and more specifically to microphone systems used for sound-recording. In particular this invention relates to the relatively new field of multichannel surround-sound technology (recording and reproduction) as used in the “5.1 surround-sound” standard of the DVD (Digital Versatile Disc).

### BACKGROUND OF THE INVENTION

It is known that two bidirectional microphones (with directional characteristics of so-called ‘figure-of-eight’; with a sensitivity equivalent to E=cos θ, wherein E is the normalized amplitude of the voltage produced by an incident sound wave of unity pressure and θ (theta) is the angle between the axis of maximum sensitivity of the microphone membrane and the direction of arrival of sound) arranged as a coincident “x-y” pair in a manner as can be seen in FIG. 1 (with their membranes angled 90 deg. to each other, and aimed at −45 deg./+45 deg. towards the sound source 0, respectively) are producing a relatively well balanced (stereophonic) sound-field. This arrangement of a pair of bi-directional microphones with a 90-degree included angle is usually referred to as “Blumlein Pair” in reference to its inventor Alan D. Blumlein (see U.S. Pat. No. 2,093,540).

Currently, several companies produce compact stereo-microphones which are made of two microphone-capsules in one housing, with which stereo-recordings of the “Blumlein-pair” type can be made (see—among others—the microphones of company AKG (Austria), model “C426” and company Neumann (Germany), model “(U)SM 69”).

It can be noted, however, that the arrangement described above sometimes exhibits some sonic limitations when being put to practical use: due to the high directionality of bi-directional microphones a given sound-source 0 at an angle of incidence of 0 deg. (as shown in FIG. 1) will tendentially suffer a degradation in terms of frequency response in comparison to sound sources (not shown) closer to the axis' of main sensitivity of the two microphones, i.e. around +/−45 deg. Depending on the given acoustics of the room also the ratio of direct-to-reverberant sound may be to the detriment of sound sources close to 0 deg. (again in comparison to other sound sources which are more “on-axis”).

(Rem.: it is generally known that—independent of the chosen directional characteristics of a microphone [omni, cardioid, figure-of-eight, etc.]—sound sources that are closer to the main axis of sensitivity of a microphone (which is usually oriented at an angle of 90 deg. relative to the membrane) will be captured with a more accurate frequency response than sound sources that are more “off-axis“.)

The above-described unwanted sonic characteristic of the Blumlein-Pair arrangement becomes even more apparent when a larger “opening-angle” (between the microphone membranes) of—say—120 deg. is being used, which may sometimes be necessary when trying to record large sound sources in relative proximity.

### BRIEF SUMMARY OF THE INVENTION

The problems as mentioned above are overcome by the present invention by adding a third bi-directional microphone-membrane to the above-described arrangement of two bi-directional microphones. This membrane is oriented at 0 deg. from center and therefore delivers a sonically stable signal for all sound-sources close to center. For a regular stereo (two-channel) recording the signal of this third microphone could be mixed equally to the left and right channel of a stereo-summing bus; however the main intention of the invention lies in the creation of a microphone able to deliver signals for the recording of surround-sound, which makes use of several separate channel-signals (In case of a 5.1 surround-recording these would be: Left , Right, Center, Left-Surround, Right-Surround, Low-Frequency-Extension).

### BRIEF DESCRIPTION OF THE DRAWINGS

FIG. 1 is a schematic diagram showing a sound-source 0 which is positioned at a 0°-angle of incidence relative to a “Blumlein-pair” microphone arrangement.

FIG. 2 (upper part) is a schematic diagram showing the 3 microphone membranes as described above in elevation view.

FIG. 2 (lower part) is a schematic diagram showing the 3 microphone membranes from above.

FIG. 3 is an elevation view of the schematic of the build of the surround-microphone, as described below, consisting of the three microphone membranes arranged one above the other, each inside a cylindrical protective microphone-enclosure.

FIG. 4 is a schematic top view of a situation in which a large sound source 9 is being recorded simultaneously by a front surround-microphone and a rear surround-microphone arrangement (of the type as described in the invention) with sound-absorptive panels 10 in between.

### DESCRIPTIONS OF THE PREFERRED EMBODIMENTS

The surround microphone in accordance with this invention comprises a microphone system for the recording of surround-sound signals with three microphones (electroacoustic transducer-elements or membranes) in a specific configuration, forming one unit, with said unit being characterized by three bi-directional microphones in one housing, which are supported on a common vertical axis, with their axes of maximum sensitivity in their normal position at azimuthal angles of −45°, +45° and 0° relative to the sound source, but each one adjustable in the horizontal dimension in a range of +/−90° according to need by means of appropriate mechanical provisions, with said three microphone elements being placed as close to each other as possible in order to create a so-called ‘coincident’ microphone arrangement, and with the signals of said three microphones being kept separate after processing through a built-in microphone pre-amplifier in order to be used as three signals of a surround-sound recording system.

The invention may be better understood with reference to the illustrations: The upper part of FIG. 2 shows a schematic arrangement of the 3 microphone membranes as described above in elevational view. They are arranged along a common vertical axis with the first membrane 1 oriented for sound pickup-from the left side , the second membrane 2 for sound pick-up from the right side and the third membrane 3 for sound pick-up from the front. The microphone membranes have to be placed as close as possible to each other. The lower part of FIG. 2 shows a top view schematic of the three membranes with their orientation in the horizontal domain. The ensemble of all three microphone membranes 1, 2, 3 is being referred to as one unit 4.

FIG. 3 is an elevational view of the schematic of the build of the surround-microphone consisting of the three microphone membranes arranged one above the other, each inside a cylindrical protective microphone-enclosure (parts 5, 6, 7). The lower part 8 of the microphone body contains the microphone's internal pre-amplifier electronics and multipin signal-connector to connect the three separate microphone signals via shielded audio-cables to the microphone inputs of a sound mixing console (commonly also referred to as “mixing desk”).

Each of the enclosures 5, 6, 7 contains the necessary suspension(s) for the microphone membrane and contact wires through which the microphone signal gets from the membrane to the microphone's internal pre-amplifier and is mechanically built in a way which makes it possible to adjust the horizontal orientation of the microphone-element as a whole in a range of at least +/−90 deg. from center. The cylindrical outside of each enclosure can be made of an acoustically transparent metal grid, as is common industry practice.

By the use of the above described microphone arrangement three of the five full frequency range signals as required for a 5.1 surround-sound recording can be obtained. These three signals will normally be the ones for the left (L), right (R) and center (C) channel, as derived from microphone membranes 1, 2 and 3.

A second unit of the above described surround-microphone can be used for pick-up of surround-sound information for the rear channels [left surround (LS), right surround (RS)]. In the event of recording signal information for the new 6.1 channel standards (Dolby 5.1 EX and DTS-ES 6.1), which call for an additional rear center-channel, the third microphone signal of membrane 3 can be used to derive that information. FIG. 4 is a top schematic view of a situation in which a large sound source 9 (for example: ensemble of musicians on a stage) is being recorded simultaneously by a front surround-microphone and a rear surround-microphone arrangement.

However, due to the bidirectional characteristics of the microphone-membranes proper placement and acoustic shielding of the rear surround-microphone will be necessary: For this purpose absorptive acoustic panels 10 can be arranged in a way to separate the surround-microphone positioned for rear-signal pick-up from all direct sound coming from the stage. The acoustic panel 10 which is positioned behind the surround-microphone for front pick-up can be used to keep unwanted acoustic room reflections from being picked up from the rear.

The distance d between the front and rear surround-microphone should be adjusted depending on the dimensions of the room, as well as on the spatial impression intended for replay: should the room sound more ‘compact’ a small spacing of 50 cm (approx. 1.5 feet), for example, (including a sound absorptive panel inbetween) may be desirable; for a more ‘spectacular’ spatial impression a spacing of up to 10 m (approx. 30 feet) might be appropriate, always depending on the specific acoustics of the room in which the recording takes place.

Although the present invention has been described in the above with reference to specific embodiments, it should be noted that various changes and modifications to the embodiments may be envisaged which fall within the scope claimed for the invention. The above specification should, therefore, be interpreted in a descriptive and not in a limiting sense.

In reference to the “Blumlein-Pair” arrangement of microphones the inventor would like to coin the term “Blumlein-Pfanzagl-Triple” for the arrangement of microphones as described in the invention.

### CROSS-REFERENCE TO RELATED APPLICATIONS

Several microphone arrangements from prior art (some of which are intended for surround sound recording) utilize a plurality of microphones. In the section below it will be analyzed in which respect they differ from the present invention:

BAUER, U.S. Pat. No. 4,262,170 describes a plurality of directional and non-directional microphones arranged with all the outputs from all microphones being summed and/or subjected to further signal processing in order to obtain 4 signals (not 5 or 6 as needed for 5.1 surround) as necessary for quadraphonic surround-sound. Among all arrangements described in that patent the following comes closest to the present invention: two bidirectional membranes (gradient microphone units 40 and 42) supported on a common vertical axis, with their axes of maximum sensitivity positioned at azimuthal angles of 90° and 0°, respectively. In this arrangement the microphone elements are placed as close as possible to each other and also in close proximity to an omnidirectional transducer element 44. (for reference see U.S. Pat. No. 4,262,170, page 10, column 3, lines 33-41 as well as FIG. 2A).

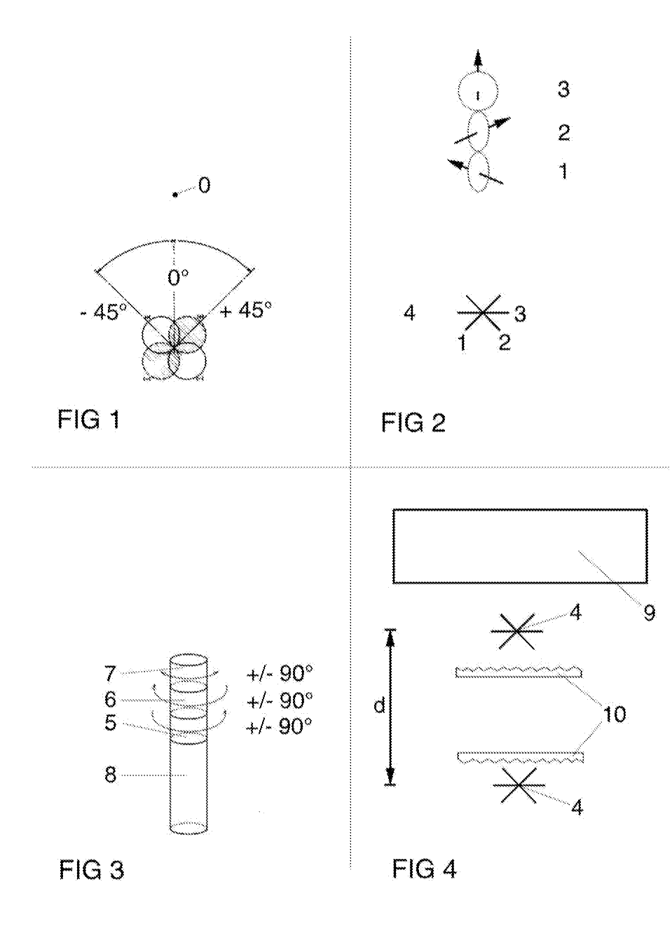

However, the signals derived from these three microphone elements are not being used in their direct form, but they are being summed and subject to further signal manipulation, and it is stated that “ . . . it being an object of the invention to provide a system equivalent in performance to that of the FIG. 1 system . . . ” (see page 10, column 3, lines 65-67), a system which in turn is aimed at providing four microphone signals with directional characteristics somewhere inbetween super- and hypercardioid aimed at −65°, +65°, −165° and +165°, respectively (see page 9, column 2, line 57 to column 3 line 3, as well as FIG. 1). To obtain the directional characteristics of the elements described in FIG. 1 a total of 5 microphone elements is being used: four bidirectional microphones and a single omnidirectional microphone.

Hence, the present invention of the “Microphone for Surround-Recording” differs not only in respect to the intended directional characteristics that are to be achieved, but also in terms of the number of physical transducer elements with bidirectional characteristics (in one case 2, in the other 4), as well as different aiming of microphone elements (or their associated generated ‘virtual’ transducer element) towards the sound-source. (Rem.: the transducer elements 40 and 42 of the above-mentioned arrangement of FIG. 2A are aimed at 0° and 90°, while in the present invention the bidirectional microphones are aimed at −45°, 0° and +45°, respectively)

The present invention describes a microphone system with a similar physical arrangement, but transducer elements of different directional characteristics, different aiming towards the sound source and a different number of surround-channel signals obtained.

Atsushi SAKAMOTO (Victor Company of Japan), U.S. Pat. No. 4,703,506 describes a device with at least three sets of microphone units (made up of 3 transducer elements each; i.e. a total of 9 microphones). However, this is a directional microphone apparatus wherein the simultaneously picked up output signals from all the microphones are summed up and filtered to produce the optimum from these different portions of the sound. Along the way the system creates first signals which are similar—but not identical—to a signal with bidirectional gradient pressure characteristic. However, these generated first signals are all perpendicular (90°) to the main lobe of said microphone apparatus. The final purpose of above described apparatus is to generate only one single output signal with strong directional characteristics (which—in addition—is not of bidirectional nature) and not the generation of several distinct signals for the use in a surround-sound system, as is the case with the present invention.

The present invention describes a microphone system with a different physical arrangement of microphones, different aiming towards the sound-source and a different number of output channel signals.

TOHIDI, U.S. Pat. No. 5,490,599 describes a microphone arrangement involving a plurality of microphones as part of a long multi-position microphone support stand. Strictly speaking, the object of the patent is the microphone stand, not the described arrangement of the microphones. In this description the microphones (with no specific directional characteristic) can be arranged in a horizontal or vertical manner with a preselected equidistant spacing between them, in order to ensure optimal simultanous pickup of—for example—a singer's voice and his guitar by two (of the plurality of) microphones. In contrast to this, it has to be understood that an essential aspect of the present invention lies in the fact that the sound pick-up should happen in a coincident manner (i.e. ideally with no spacing between the microphone-membranes at all).

The present invention describes a microphone system with different physical arrangement and purpose (surround).

Yannick MAHIEUX et al. (FRANCE TELCOM), EP 781,070 describes a plurality of microphones arranged linearly along a horizontal axis at differing intervals (d, 2 d, 4 d). A total of 8 microphones is being used along with summing and signal processing circuitry in order to form an audio signal representative of one (virtual) transducer element with complex adjustable directional characteristic, according to need.

The present invention describes a microphone system with different physical arrangement and purpose (surround).

Akitaka ITO (SONY Corp. Tokyo) EP 1,259,097 describes a surround sound field reproduction system and method with a total of 8 microphones arranged on an overall celestial sphere. Six microphones are disposed horizontally at equal distances (60 degrees) in a circumferential direction such that they are directed in radially outward directions, and two microphones are disposed vertically at the top and bottom such that they are directed in upward and downward directions, respectively. The signals of all 8 microphones are being subject to further signal processing (namely horizontal and vertical panning) in order to enable the intended localization when signals are being played back over a 5.1 surround loudspeaker system. The microphone arrangement described herein uses the directional characteristics of the transducer elements, as well as time-of-arrival differences due to their physical position in relation to the sound source(s) to achieve localization upon playback. The second aspect represents a major difference in respect to the present invention, which uses a so-called “coincident” (one-point) arrangement of microphones with the transducer elements as close to each other as possible.

Therefore the present invention describes a microphone system with a quite different physical arrangement of microphones, different aiming towards the sound-source and a different number of surround-channel signals.

1. A microphone system for the recording of surround-sound signals with three microphones (electroacoustic transducer-elements or membranes) in a specific configuration, forming one unit, with said unit being characterized by three bi-directional microphones in one housing, which are supported on a common vertical axis, with their axes of maximum sensitivity in their normal position at azimuthal angles of −45°, +45° and 0° relative to the sound source, but each one adjustable in the horizontal dimension in a range of at least +/−90°, according to need, by means of appropriate mechanical provisions, with said three microphone elements being placed as close to each other as possible in order to create a so-called ‘coincident’ microphone arrangement, and with the signals of said three microphones being kept separate after processing through a built-in microphone pre-amplifier in order to be used as three signals of a surround-sound recording system.

2. A three channel surround-microphone device substantially as herein described with reference to the accompanying drawings.
